(19) United States
(12) Patent Application Publication
(10) Pub. No.: US 2006/0028693 A1
(43) Pub. Date: Feb. 9, 2006

(54) Fax machine

(76) Inventor: Tetsuya Kagawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/194,527

(22) Filed: Aug. 2, 2005

(30) Foreign Application Priority Data
Aug. 3, 2004 (JP) 2004-227085

(51) Int. Cl. G06K 15/00

(52) U.S. Cl. 358/403; 358/400; 358/1.14

(57) ABSTRACT

A fax machine is disclosed. A document to be transmitted is placed on the fax machine, and it is determined whether a function for preventing transmission of a “copy prohibited document” is enabled. If the function is disabled, normal fax transmission is performed. If, on the other hand, the function is enabled, a scanner reads all the pages of the document at a time. Then, it is determined whether the read document includes “copy prohibit information” at a predetermined spot. If the copy prohibit information is not detected, a transmission operation is performed and a series of operations is completed. If, on the other hand, the copy prohibit information is detected, the transmission operation is terminated and images and/or text indicating that the transmission is not allowed are displayed. Thus, a series of operations is completed.

### BACKGROUND OF THE INVENTION

1. Field of the Invention

The present invention relates to a fax machine having a function that prevents unauthorized fax transmission.

2. Description of the Related Art

In conventional copy machines and printers, embedding a special mark unnoticeable to readers in a document to be kept secret from outsiders is commonly performed in order to prevent unauthorized reproduction of the document. For example, Patent Document 1 discloses a technique for embedding information about a copy machine used for reproduction of a document or associated information of the document into a hard copy when outputting it. Recently, for the purpose of recycling recording paper on which images are printed, a technique has been proposed that dissolves and removes toner previously applied on the recording paper (see, for example, Patent Document 2). With this technique, unfortunately, a sheet with a seal remaining thereon might be used for forging a document by a person who is not authorized to use the seal. Meanwhile, techniques for preventing such falsification of documents are also proposed (see, for example, Patent Document 3).

[Patent Document 1] Japanese Patent Laid-Open Publication No. 2003-205661

[Patent Document 2] Japanese Patent Laid-Open Publication No. 1-101576

[Patent Document 3] Japanese Patent Laid-Open Publication No. 7-129050

The above copy protection techniques are effective in copy machines and printers. However, even if a special mark unnoticeable to readers is embedded on a document, fax transmission of the document is still possible. Therefore, documents to be kept secret from outsiders might be accidentally or intentionally transmitted by fax.

### SUMMARY OF THE INVENTION

In view of the foregoing, it is an object of the present invention to prevent unauthorized fax transmission.

According to an aspect of the present invention, there is provided a fax machine, comprising detection means for detecting whether copy prohibit information for preventing unauthorized copying is contained in a document to be transmitted by fax, and control means for terminating a fax transmission of the document if the copy prohibit information is detected.

It is preferable that the above-described fax machine further comprise processing means for processing a page in which the copy prohibit information is detected to make data on the page unreadable, that the detection means detect whether the copy prohibit information is contained in the document on a per-page basis, and that the control means transmit a page in which the copy prohibit information is not detected and the processed page.

It is also preferable that the above-described fax machine further comprise storage means for storing a transmission record indicating that the fax transmission is not performed in response to a detection of the copy prohibit information.

It is also preferable that the above-described fax machine further comprise input means for inputting a code for identifying a user who transmits the document by facsimile, and that the storage means store the input code along with the transmission record indicating that the fax transmission is not performed in response to the detection of the copy prohibit information.

It is also preferable that the above-described fax machine further comprise register means for registering a contact address of an administrator, and report means for reporting to the registered address of the administrator that the transmission is not performed in response to a detection of the copy prohibit information.

According to the present invention, as the fax transmission is terminated in response to the detection of the copy prohibit information, unauthorized disclosure of document contents can be prevented as long as the fax machine of the present invention is used, thus improving the information security.

### BRIEF DESCRIPTION OF THE DRAWINGS

FIG. 1 illustrates an example of a document unauthorized copying of which is prohibited;

FIG. 2 is a block diagram showing a system configuration of a fax machine according to an embodiment of the present invention;

FIG. 3 is a flowchart showing operations of a fax machine according to a first embodiment of the present invention;

FIG. 4 is a flowchart showing operations of a fax machine according to a second embodiment of the present invention;

FIG. 5 is a flowchart showing operations of a fax machine according to a third embodiment of the present invention;

FIG. 6 is a flowchart showing operations of a fax machine according to a fourth embodiment of the present invention; and

FIG. 7 is a flowchart showing operations of a fax machine according to a fifth embodiment of the present invention.

### DETAILED DESCRIPTION OF THE PREFERRED EMBODIMENT

The following description provides exemplary embodiments of the present invention with reference to the accompanying drawings.

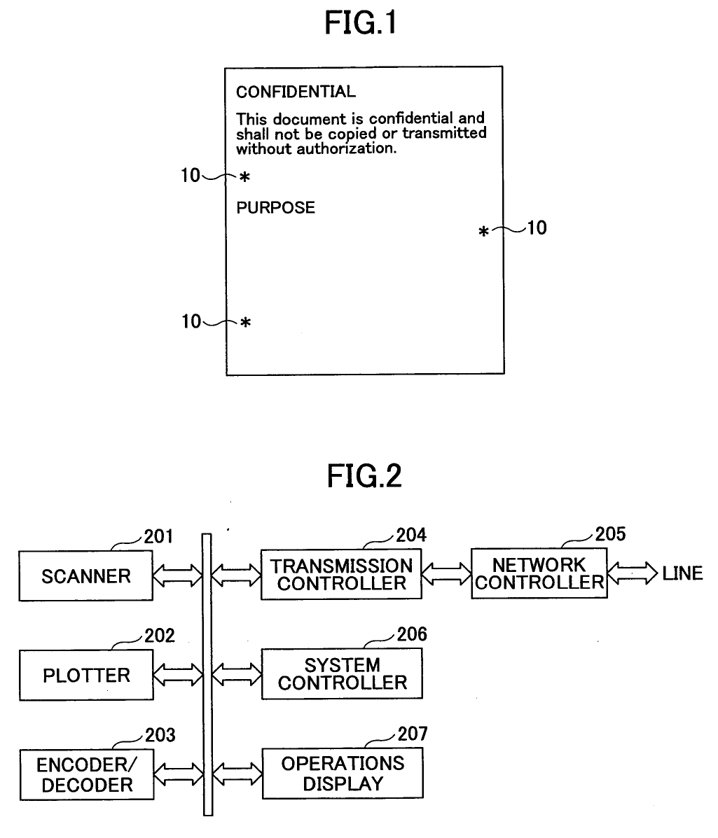

FIG. 1 illustrates an example of a document on which special marks (copy prohibit information 10) for preventing unauthorized copying are printed. In this example, “*” marks or copy prohibit information 10 are automatically printed on predetermined three spots when the document is printed out. A copy machine detects these three marks at the time of copying the document, and disables copying of the document.

According to an embodiment of the present invention, fax transmission is terminated upon detection of the copy prohibit information 10 such as the above described special mark.

FIG. 2 is a block diagram showing a system configuration of a fax machine according to an embodiment of the present invention.

With reference to FIG. 2, the fax machine comprises a scanner 201 for scanning an original document, a plotter 202 for printing received images, an encoder/decoder 203 for compressing and decompressing image information, a transmission controller 204 for performing transmission, a network controller 205 connected to a line for originating and receiving calls, a system controller 206 for performing control operations according to this embodiment and controlling fax transmission, and an operations display 207 for providing visual information to operators and used for input operations by operators. The scanner 201 and the system controller 206 are configured to detect the copy prohibit information 10. If a document is determined as a copy prohibited document, predetermined images and/or text are displayed on the operations display 207 and/or a processing operation that makes sending images to be sent blank.

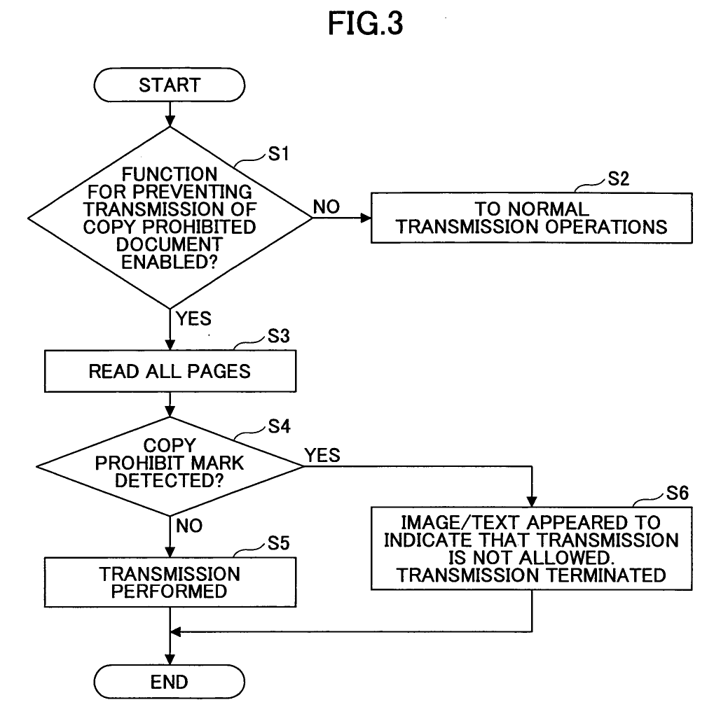

FIG. 3 is a flowchart showing operations of the fax machine according to a first embodiment of the present invention.

A document to be transmitted is placed on the fax machine, and it is determined whether a function for preventing transmission of copy prohibited documents is enabled or disabled (step S1). If the function is disabled, normal fax transmission is performed (step S2). If, on the other hand, the function is enabled, the scanner 201 reads all the pages of the document at a time (step S3). Then, it is determined whether the read document includes copy prohibit information 10 at a predetermined spot. If the copy prohibit information 10 is not detected, transmission is performed (step S5). Thus, a series of operations is completed (step S5). If, on the other hand, the copy prohibit information 10 is detected, the transmission is terminated and images and/or text indicating that the transmission is not allowed are displayed (step S6). Thus, a series of operations is completed. Enabling and disabling the function for preventing transmission of copy prohibited documents referred to in step S1 is selected by a user with use of the operations display 207.

According to this embodiment, fax transmission is terminated upon detection of the copy prohibit information 10, such as special marks used for preventing unauthorized copying, and such information is reported to a user. Therefore, unauthorized disclosure of documents are prevented as long as this fax machine is used, thus improving the information security.

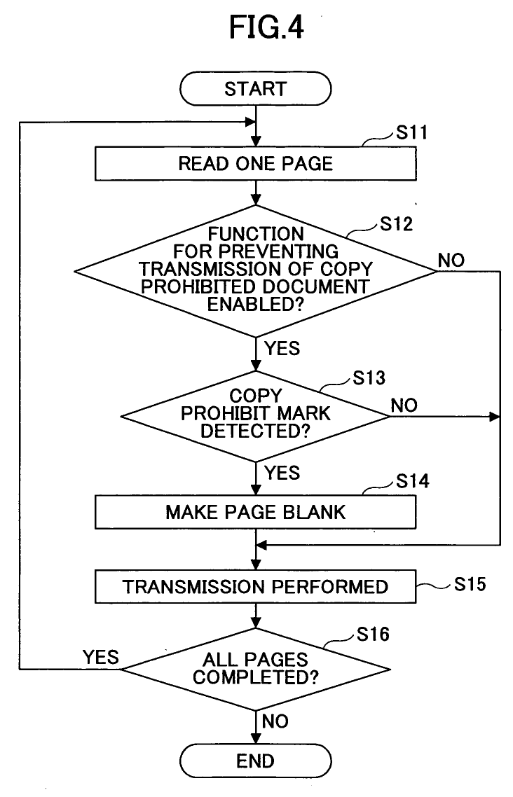

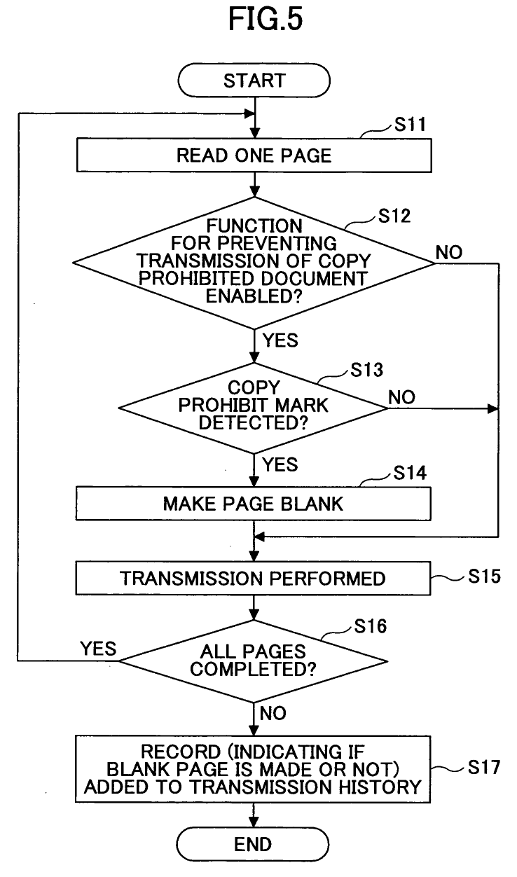

FIG. 4 is a flowchart showing operations of the fax machine according to a second embodiment of the present invention.

In the second embodiment, determination whether transmission is allowed is made page by page. More specifically, a document is read page by page (step S11), and it is determined whether the function for preventing transmission of copy prohibited documents is enabled or disabled (step S12). If the function is enabled, it is determined whether the copy prohibit information 10 is present. If the copy prohibit information 10 is detected, data on a page with the copy prohibit information 10 is made blank (step S14). Then, the transmission is performed (step S15). If, on the other hand, the function for preventing transmission of copy prohibited documents is disabled in step S12, or if the copy prohibit information 10 is not detected in step S13, normal transmission is performed in step S15. The above operations are performed for each page (step S16), and thus a series of operations are completed. Although the page with the copy prohibit information 10 is made blank in this embodiment, other operations for making the page unreadable may be applicable.

According to this embodiment, a page of a document in which the copy prohibit information 10 is embedded is transmitted as a blank page. This can avoid inconvenience of not being able to transmit the entire document or not being able to transmit the document until all the pages are read as in the first embodiment. As the transmission of pages without the copy prohibit information 10 is allowed, it is possible to specifying confidential information contained in the document in more detail, thus improving the information security.

FIG. 5 is a flowchart showing operations of the fax machine according to a third embodiment of the present invention, wherein steps corresponding to the steps shown in FIG. 4 bear the same step numbers and are not further described.

In the third embodiment of the present invention, an operation for recording the presence of a copy prohibited page into a transmission history (step S17) is added to the operations of the second embodiment.

According to this embodiment, when the copy prohibit information 10 is detected, a record on an attempt to transmit a document with the copy prohibit information 10 or a record indicating that a page is made blank is stored into a transmission history. As the attempt of transmitting the document with the copy prohibit information 10 is recorded and the record can be referred to afterward, the information security regarding users can be improved.

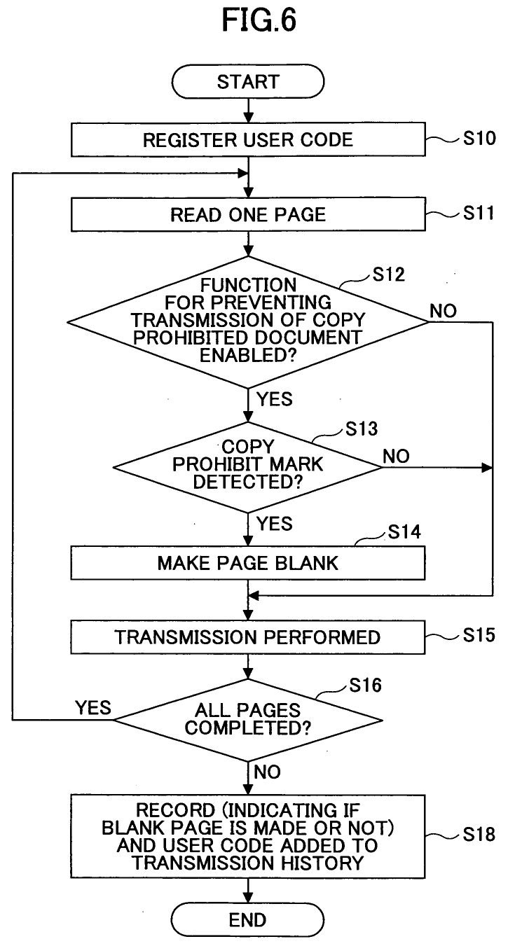

FIG. 6 is a flowchart showing operations of the fax machine according to a fourth embodiment of the present invention, wherein steps corresponding to the steps shown in FIG. 5 bear the same step numbers and are not further described.

In the fifth embodiment, a user code is input when the fax machine is used. A password may also be input in order to improve user identification accuracy. Then the same operations as in the third embodiment are performed. When transmission history data are created after completion of the transmission, the user code is also recorded.

According to this embodiment, inputting a code for identifying a user of the fax machine is required when the function for preventing unauthorized disclosure of documents is enabled. Therefore, it is possible to identify a person who tried to transmit a confidential document based on a code input by the person, thus improving the information security regarding users.

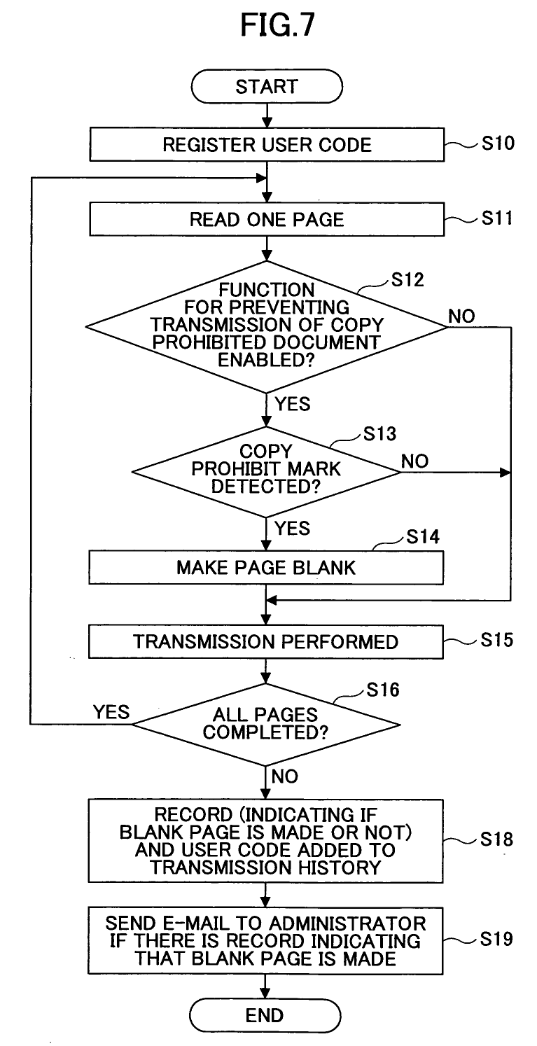

FIG. 7 is a flowchart showing operations of the fax machine according to a fifth embodiment of the present invention, wherein steps corresponding to the steps shown in FIG. 6 bear the same step numbers and are not further described.

In this embodiment, operations in steps S10 through S18 are the same as those in the fourth embodiment. After the history data are created in step S18, when there is a record indicating that a page is made blank in the transmission history, such information is reported to an administrator of the fax machine by sending e-mail to the administrator (step S19). Sending e-mail is easy if the fax machine has an Internet facsimile function.

According to this embodiment, if the function for preventing unauthorized disclosure of documents is enabled and the copy prohibit information 10 is detected, the fax machine automatically reports the detection of the copy prohibit information 10 to an administrator registered in advance. Therefore, the administrator can know about an unauthorized use at an early stage and prevent damage from spreading. That is, because the administrator receives a report at the time when a confidential document is transmitted, the information security can be improved.

The copy prohibit information 10 is not limited to the special mark described in the above embodiments but may be any information readable by the scanner 201 including other embedded information.

The present application is based on Japanese Priority Application No. 2004-227085 filed on Aug. 3, 2004, with the Japanese Patent Office, the entire contents of which are hereby incorporated by reference.

What is claimed is:

1. A fax machine, comprising:
detection means for detecting whether copy prohibit information for preventing unauthorized copying is contained in a document to be transmitted by fax; and
control means for terminating a fax transmission of the document if the copy prohibit information is detected.

2. The fax machine as claimed in claim 1, further comprising:
processing means for processing a page in which the copy prohibit information is detected to make data on the page unreadable;
wherein the detection means detects whether the copy prohibit information is contained in the document on a per-page basis; and
the control means transmits a page in which the copy prohibit information is not detected and the processed page.

3. The fax machine as claimed in claim 1, further comprising:
storage means for storing a transmission record indicating that the fax transmission is not performed in response to a detection of the copy prohibit information.

4. The fax machine as claimed in claim 3, further comprising:
input means for inputting a code for identifying a user who transmits the document by facsimile;
wherein the storage means stores the input code along with the transmission record indicating that the fax transmission is not performed in response to the detection of the copy prohibit information.

5. The fax machine as claimed in claim 1, further comprising:
register means for registering a contact address of an administrator; and
report means for reporting to the registered address of the administrator that the transmission is not performed in response to a detection of the copy prohibit information.

6. A fax machine, comprising:
a detection unit configured to detect whether copy prohibit information for preventing unauthorized copying is contained in a document to be transmitted by fax; and
a control unit configured to terminate a fax transmission of the document if the copy prohibit information is detected.

7. The fax machine as claimed in claim 6, further comprising:
a processing unit configured to process a page in which the copy prohibit information is detected to make data on the page unreadable;
wherein the detection unit detects whether the copy prohibit information is contained in the document on a per-page basis; and
the control unit transmits a page in which the copy prohibit information is not detected and the processed page.

8. The fax machine as claimed in claim 6, further comprising:
a storage unit configured to store a transmission record indicating that the fax transmission is not performed in response to a detection of the copy prohibit information.

9. The fax machine as claimed in claim 8, further comprising:
an input unit configured to input a code for identifying a user who transmits the document by facsimile;
wherein the storage unit stores the input code along with the transmission record indicating that the fax transmission is not performed in response to the detection of the copy prohibit information.

10. The fax machine as claimed in claim 6, further comprising:
a register unit configured to register a contact address of an administrator; and
a report unit configured to report to the registered address of the administrator that the transmission is not performed in response to a detection of the copy prohibit information.

11. A method for transmitting a document by fax, comprising:
a detection step of detecting whether copy prohibit information for preventing unauthorized copying is contained in a document to be transmitted by fax; and
a control step of terminating a fax transmission of the document if the copy prohibit information is detected.
